(19) United States
(12) Patent Application Publication
(10) Pub. No.: US 2024/0112152 A1
(43) Pub. Date: Apr. 4, 2024

(54) HIERARCHICAL PAYMENT STRUCTURES

(71) Applicant: Projectpay Ltd, London (GB)

(72) Inventor: Louise Stewart, Fulham (GB)

(21) Appl. No.: 17/960,439

(22) Filed: Oct. 5, 2022

(30) Foreign Application Priority Data
Sep. 29, 2022 (GB) 2214314.3
Sep. 30, 2022 (GB) 2214431.5

(51) Int. Cl. G06Q 20/02; G06Q 20/36; G06Q 20/40

(52) U.S. Cl. CPC G06Q 20/02; G06Q 20/36; G06Q 20/40

(57) ABSTRACT

In some examples, a machine-readable storage medium encoded with instructions for executing payment in a trusted environment comprising a first party and a set of sub-parties defining a hierarchical structure of payees, whereby to cause the apparatus to receive data representing a funding instance, receive, from the first party, request data comprising a tuple defining at least one of a payment request, a payment party, and a payment amount, process the request data to parse a set of payment information for the first party and the set of sub-parties, determine, using the payment information, at least one entry in a data structure defining at least one digital wallet and comprising an approved funding source of the payment request, execute a payment order to at least the first party and the set of sub-parties, and modify at least one entry of the data structure to reflect execution of the payment order.

### TECHNICAL FIELD

The present disclosure relates, in general, to hierarchical payment structures. Aspects of the disclosure relate to managing contractual payment between parties in construction, building or development projects.

### BACKGROUND

Construction, building or development projects involve a large number of stakeholders from primary contractors to multiple subcontractors. Contractors can provide goods, such as building materials for example, and/or services, such as building and construction services, plumbing, electrical services and so on. There are, of course, many other types of goods and/or services applicable to the construction industry.

A subcontractor for example will typically seek payment for a supplied good and/or a service from a primary contractor, which will generally be the contractor that engages the subcontractor in question. For example, a general contractor may engage a plumber to perform certain tasks in relation to a construction project. In an example, a task can comprise a job, assignment or piece of work, which may need to be performed within a predefined period of time.

After having fulfilled the task, the subcontractor can notify the primary contractor and seek payment. However, it can often be the case that a subcontractor is either not paid, not paid in full, or that a payment request is delayed or queried because of, e.g., incomplete, missing or incorrect paperwork relating to either or both of the task performed and the payment request itself. Counter party payment risks can also be encountered, for example when a primary contractor requests payment for works completed by their subcontractors but subsequently fails to pass on payments due.

### SUMMARY

An objective of the present disclosure is to provide an end-to-end payment system and platform. Such a platform can be used in the construction industry, but also has utility in many other fields. Payments can be made or funds distributed to all parties in a supply chain utilising digital wallets, at all levels, without delay. As such, a cascading payment structure is provided and regulated.

The foregoing and other objectives are achieved by the features of the independent claims.

Further implementation forms are apparent from the dependent claims, the description and the Figures.

A first aspect of the present disclosure provides a machine-readable storage medium encoded with instructions for executing payment in a trusted environment comprising a first party and a set of sub-parties defining a hierarchical structure of payees, the instructions executable by a processor of an apparatus comprising a memory configured to store a data structure defining at least one digital wallet for the trusted environment, whereby to cause the apparatus to receive data representing a funding instance, the data defined according to a preconfigured contract between the first party and a funding party, receive, from the first party, request data comprising a tuple defining at least one of a payment request, a payment party, and a payment amount, process the request data to parse a set of payment information for the first party and the set of sub-parties, determine, using the payment information, at least one entry in the data structure comprising an approved funding source of the payment request, execute a payment order to at least the first party and the set of sub-parties, and modify at least one entry of the data structure, whereby to reflect execution of the payment order.

In an implementation of the first aspect, a first party, such as a main contractor, and other parties, such as sub-contractors for example, can onboard themselves to a platform and/or be invited to accept a contract relating to a project. In another implementation of the first aspect, a first party, such as a main contractor can create a live project and invite other parties such as such as sub-contractors for example to become part of the project. Contract and payment milestones for all parties can be stored as part of, e.g., a digital ledger, and can be lodged within the platform. Payment requests, approvals, retentions and transactions can all be managed and tracked live across an entire supply chain.

In an example, the machine-readable storage medium can be encoded with further instructions to cause the apparatus to request, on the basis of the data representing the funding instance, attestation data relating to the funding instance and defining a payment structure therefor. The machine-readable storage medium can be encoded with further instructions to cause the apparatus to determine a fee to be applied, and modify at least one entry of the data structure, whereby to reflect application of the fee to one or more of an amount of the payment order, and an amount of the funding instance.

The machine-readable storage medium can be encoded with further instructions to cause the apparatus to record data related to at least one of a funding instance, a payment request, a payment party, a payment amount, payment information, an approved funding source of the payment request, and a payment order to a digital ledger. The machine-readable storage medium can be encoded with further instructions, whereby to cause the apparatus to regulate access to the digital ledger using an authentication module.

A second aspect of the present disclosure provides a method, performed in apparatus of a trusted environment comprising a data structure defining a digital wallet for the trusted environment, the method comprising receiving, from a first party, data representing a funding instance, the data defined according to a preconfigured contract between the first party and a funding party, receiving request data comprising a tuple defining at least one of a payment request, a payment party, and a payment amount, processing the request data to parse a set of payment information, determining, using the payment information, at least one entry in the data structure comprising an approved funding source of the payment request, executing a payment order to at least the first party and a set of sub-parties defining a hierarchical structure of payees, and modifying at least one entry of the data structure, whereby to reflect execution of the payment order.

The method can further comprise recording data related to at least one of a funding instance, a payment request, a payment party, a payment amount, payment information, an approved funding source of the payment request, and a payment order to a digital ledger. The method can further comprise regulating access to the digital ledger using an authentication module.

In an implementation of the second aspect, the method can further comprise requesting, on the basis of the data representing the funding instance, attestation data relating to the funding instance and defining a payment structure therefor. The method can further comprise determining a fee to be applied, and modifying at least one entry of the data structure, whereby to reflect application of the fee to one or more of an amount of the payment order, and an amount of the funding instance.

A third aspect of the present disclosure provides an apparatus of a trusted environment comprising a data structure defining a digital wallet for the trusted environment, the apparatus comprising a processor, a memory coupled to the processor, the memory configured to store program code executable by the processor, the program code comprising one or more instructions, whereby to cause the apparatus to receive, from a first party, data representing a funding instance, the data defined according to a preconfigured contract between the first party and a funding party, receive request data comprising a tuple defining at least one of a payment request, a payment party, and a payment amount, process the request data to parse a set of payment information, determine, using the payment information, at least one entry in the data structure comprising an approved funding source of the payment request, execute a payment order to at least the first party and a set of sub-parties defining a hierarchical structure of payee, and modify at least one entry of the data structure, whereby to reflect execution of the payment order.

In an implementation of the third aspect, the program code can comprise further instructions, whereby to cause the apparatus to request, on the basis of the data representing the funding instance, attestation data relating to the funding instance and defining a payment structure therefor. The program code can comprise further instructions, whereby to cause the apparatus to determine a fee to be applied, and modify at least one entry of the data structure, whereby to reflect application of the fee to one or more of an amount of the payment order, and an amount of the funding instance.

The program code can comprise further instructions, whereby to cause the apparatus to record data related to at least one of a funding instance, a payment request, a payment party, a payment amount, payment information, an approved funding source of the payment request, and a payment order to a digital ledger. The program code can comprise further instructions, whereby to cause the apparatus to regulate access to the digital ledger using an authentication module.

These and other aspects of the invention will be apparent from the embodiment(s) described below.

### BRIEF DESCRIPTION OF THE DRAWINGS

In order that the present invention may be more readily understood, embodiments of the invention will now be described, by way of example, with reference to the accompanying drawings, in which:

FIG. 1 is a schematic representation of a hierarchical structure of payees according to an example; and

FIG. 2 is a schematic representation of a machine according to an example.

### DETAILED DESCRIPTION

Example embodiments are described below in sufficient detail to enable those of ordinary skill in the art to embody and implement the systems and processes herein described. It is important to understand that embodiments can be provided in many alternate forms and should not be construed as limited to the examples set forth herein.

Accordingly, while embodiments can be modified in various ways and take on various alternative forms, specific embodiments thereof are shown in the drawings and described in detail below as examples. There is no intent to limit to the particular forms disclosed. On the contrary, all modifications, equivalents, and alternatives falling within the scope of the appended claims should be included. Elements of the example embodiments are consistently denoted by the same reference numerals throughout the drawings and detailed description where appropriate.

The terminology used herein to describe embodiments is not intended to limit the scope. The articles “a,” “an,” and “the” are singular in that they have a single referent, however the use of the singular form in the present document should not preclude the presence of more than one referent. In other words, elements referred to in the singular can number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art. It will be further understood that terms in common usage should also be interpreted as is customary in the relevant art and not in an idealized or overly formal sense unless expressly so defined herein.

Legislation in, for example, the UK and Australia does not allow a main contractor to delay payment to their subcontractors because they have not been paid by the project owner yet. “Paid when paid” provisions are generally outlawed in the construction industry. Typically a subcontractor is not a party to the main contractors agreement with the project owner. As such the main contractor has an obligation to pay the subcontractor within agreed terms in the subcontract agreement or in accordance with legally stipulated timeframes. For example, legislation may stipulate that the main contractor must issue a payment notice within a predefined period of the payment request date to confirm what is approved to be paid. The main contractor has an obligation to pay this regardless of what the project owner agrees to pay them for the same claim period or even if the project owner has not paid them yet.

Often main contractors do not have access to affordable working capital to pay their subcontractors before they have been paid by the project owner. According to an example, a system and platform is provided in which all payment requests and approvals (Payment Notices) are lodged across the whole payment hierarchy, and where there already exists qualified project funding. Accordingly, payment risks are removed. In an example, a digital wallet or wallets is funded with certified payment amounts (from payment notices). A percentage fee can be levied that can be paid when a project owner (e.g., a funding party) pays. However, if the project owner does not pay in accordance with their contract with a main contractor, the system can, e.g., exercise interest over the project owners property until payment is made or the property is sold to provide outstanding payment.

According to an example, there is provided a process for executing a payment or payments in a trusted environment comprising a first party and a set of sub-parties defining a hierarchical structure of payees. In general, the first party comprises a primary or general contractor who may be leading, overseeing or otherwise managing a project, such as a construction project for example. A sub-party comprises a subcontractor, such as a subcontractor hired or otherwise engaged by the primary contractor for the purposes of providing goods and/or services in relation to the fulfillment of the project. The trusted environment defines at least a set of contractual obligations between parties, such as between the first party and one or more of the set of sub-parties. That is, the trusted environment defines a framework comprising a set commitments or responsibilities between parties that may be, e.g., enforceable such that, for example, specific performance of a predefined task and/or supply of goods and/or services can take place. In an example, parties can create a project and enter into contracts at all levels which dictate cascading payment terms in compliance with the contracts and, e.g., security of payment Acts or legislation in the relevant jurisdiction. This is contrast to the current prevailing mechanisms in which all levels may have individual contracts that may not generally be linked in any meaningful way to a root contract (which means that if payments are not passed on there is little recourse to enforce payments).

In an implementation, an apparatus comprising a memory can be configured to store a data structure defining at least one digital wallet for the trusted environment. The digital wallet can comprise a ringfenced repository or container for holding funds related to a project, which may be funded by a funding party who may be, for example, the first party described above. In an example, the funding party can be a party that engages the first party to execute a project on their behalf. A funding instance can be represented by data stored as part of the data structure. That is, the addition (and/or removal) of and presence of funds relating to a project can be recorded in the digital wallet as part of a marked-up set of data. In an example, the marked-up set of data comprises information representing a preconfigured contract between the first party and a funding party, and/or between the first party and at least some of the set of sub-parties. Thus, the data structure can act as a ledger for a project that enables transactions associated with the project to be recorded. Storage of a transaction may be temporary, lasting, for example, until a related project is complete, or may be longer lived enabling it to be viewed as, e.g., a historical record for a project.

Each transaction, such as the funding instance, can be linked in the digital wallet with at least one of data representing a project, a first party, the set of sub-parties, a payment request and a payment amount. As such, a logical link exists between a transaction such as a funding instance and the corresponding project and involved parties. As such, a request for payment, which can comprise data representing a tuple defining at least one of a payment request, a payment party, and a payment amount can be initiated by a party, such as the first party for example, and easily linked to data in the digital wallet that enables the apparatus to determine the presence of suitable funds. So, for example, a request for payment initiated by the first party can be made on behalf of any one or more of the sub-parties for example, and may be in response to confirmation of completion or delivery of goods or services. In an example, each level for a project can comprise a claimant and/or a respondent. Once requests for payments are dealt with, a respondent can submit their request for payment to their approving party. All applications for payments are made in accordance with the contractually agreed works and actioned on the platform. Only approved applications can be paid and adjustments or disputes can be referred to adjudication for a determination to enable payments to flow.

According to an example, a request for payment initiated by the first party can trigger payment to be effected on behalf of the first party to at least one other party. For example, as delivery of multiple goods and/or services in respect of a project may be contingent on completion of a chain of tasks, which may be intrinsically linked to one another, or otherwise dependent or conditional on one another in some respect, triggering a release of funds can execute payment to a hierarchical structure of payees. For example, successful completion of one task in respect of part of a project may be conditional on completion of multiple other tasks and/or delivery of certain goods. Parties associated with the tasks/goods can form part of the set of sub-parties and can be logically linked together to form a hierarchy such that payment to one party in the set is contingent on another party in the set having, e.g., completed a task assigned to or associated with them. In some cases, a sub-party may be, e.g., a sub-contractor of a sub-contractor. That is, a first sub-contractor engaged by the first party (e.g., a general contractor) may themselves engage a second sub-contractor for some specific tasks and/or for the supply of some goods. A payment to the second sub-contractor in such an instance would be effected by the first sub-contractor. However, the first sub-contractor may withhold funds for reasons that are outside of the control of the second sub-contractor. For instance, the first subcontractor may not pay the second subcontractor in favour of other payees, which could ultimately result in the second subcontractor not being paid.

According to an example, because of the link between the first subcontractor and the second subcontractor, and the association between them and a corresponding project, a payment triggered to the first subcontractor will automatically trigger payment to the second subcontractor. For example, since the tasks of the first subcontractor can be considered to be contingent on successful completion of tasks of the second subcontractor, payment to the second subcontractor cannot be withheld (or indeed controlled by) the first subcontractor. Rather, in an implementation, a payment request that results in payment of the first subcontractor will trigger payment to an associated number of sub-parties from set of sub-parties so linked to form a hierarchical structure of payees for a project or part of a project for which the first subcontractor is responsible. Put another way, when part of a project is completed and a first subcontractor is paid using the funds from the digital wallet, sub-parties associated with the task of the first subcontractor will also be paid using the funds from the digital wallet. Thus, payment of sub-parties in a hierarchy of contractors is not dependent on the hiring/engaging party paying. Rather, a logical link between parties results in a hierarchical structure of payees in which payments are cascaded down the structure to all concerned parties. Once a payment has been made, the data structure, or at least least one entry thereof, can be modified in order to reflect execution of a payment order triggered by the payment request.

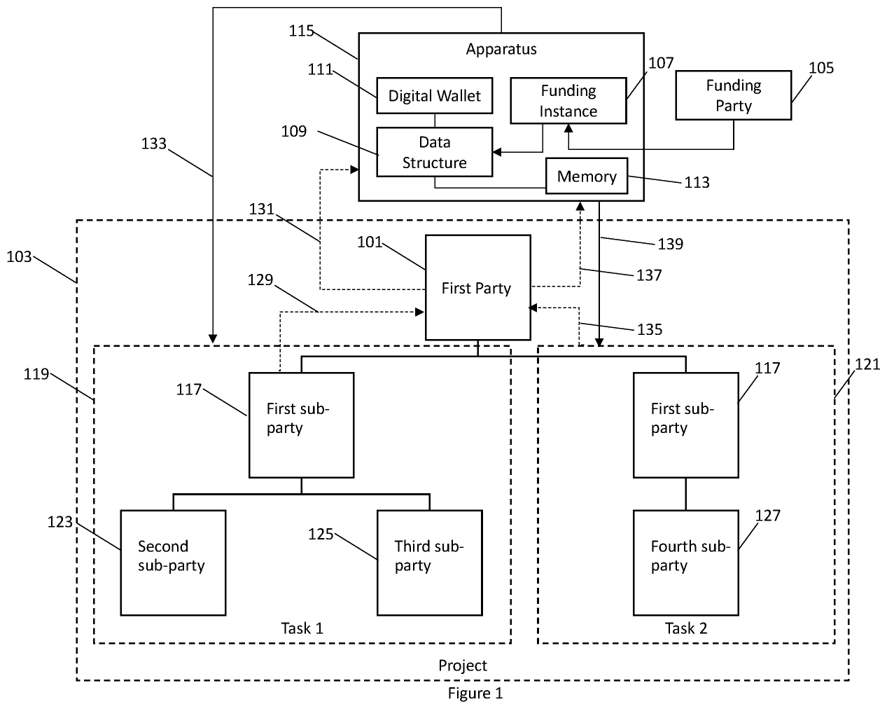

FIG. 1 is a schematic representation of a hierarchical structure of payees according to an example. In the example of FIG. 1, a first party 101 represents a primary contractor associated with a project 103. That is, the first party 101 is involved in supplying goods or services in respect of the project 103. The project 103 has an associated funding party 105 who funds the project, at least partly. As such, the funding party 105 provides a funding instance 107, which can comprise funds proper or a guarantee of availability of funds. The funding instance 107 can be recorded using the data structure 109 as part of the digital wallet 111. For example, an entry for the digital wallet 111 can specify one or more of the amount of the funding instance, the project 103 to which it relates, and the primary contractor associated with the project 103 (e.g., the first party 101). According to an example, the data structure 109 can be stored on a memory 113 of apparatus 115.

Data structure 109 comprises data defining a logical structure between the first party 101 and a set of sub-parties. The logical structure can be based on, enshrined in or otherwise determined on the basis of a contractual relationship between the parties. For example, a contractual relationship for the provision of goods or services to the first party 101 can form the basis of part of a logical structure that defines a hierarchical structure representing the disposition of the parties with respect to one another. In the example of FIG. 1 for example, the first party 101, as the primary contractor in connection with the project 103, has a contractual relationship with a first sub-party 117, which can comprise a first sub-contractor associated with project 103. Specifically, the first sub-party 117 is associated with a first task 119 and a second task 121 for the project 103. One or both of the tasks can be for the supply of goods and/or services. That is, the first party 101 subcontracts to the first sub-party for some tasks associated with the project 103. In the example of FIG. 1, considering the first task 119, the first sub-party 117 further sub-contracts to a second sub-party 123 and a third sub-party 125. Considering the second task 121, the first sub-party 117 further sub-contracts to a fourth sub-party 125.

The first task 119 can be considered complete when the first sub-party 117 has completed their task, which can be contingent on the second sub-party 123 and the third sub-party 125 having completed their sub-contracted tasks. Accordingly, the first sub-party 117 may submit a request for payment 129 to the first party 101 in respect of the first task 119. The first party 101 can then submit a payment request 131 to apparatus 115 in order to trigger a payment 133 from the digital wallet 111. Specifically, as there is a logical link in the data structure between the first sub-party 117 and the second and third sub-parties in relation to the first task 119, an approved payment 133 from the digital wallet is made to the first sub-party 117 as well as the second and third sub-parties, who together form a hierarchical structure of payees for the first task 119. That is, payment to at least the second and third sub-parties is not contingent upon a release of funds by the first sub-party 117. Rather, payment to all parties associated with the first task 119 is contingent on completion of the first task 119 and approval by the first party 101. As such, the second and third sub-parties are not beholden to the first sub-party for payment to the extent that payment may be delayed or unreasonably withheld and so on.

In the example of FIG. 1, considering the second task 121, the first sub-party 117 further sub-contracts to a fourth sub-party 127, and the second task 121 can be considered complete when the first sub-party 117 has completed their task, which can be contingent on the fourth sub-party 127 having completed their sub-contracted task. Accordingly, the first sub-party 117 may submit a request for payment 135 to the first party 101 in respect of the second task 121. The first party 101 can then submit a payment request 137 to apparatus 115 in order to trigger a payment 139 from the digital wallet 111. Specifically, as there is a logical link in the data structure between the first sub-party 117 and the fourth sub-party 127 in relation to the second task 121, an approved payment 139 from the digital wallet is made to the first sub-party 117 as well as to the fourth sub-party 127, who together form a hierarchical structure of payees for the second task 121. That is, payment to the fourth sub-party 127 is not contingent upon a release of funds by the first sub-party 117. Rather, payment to all parties associated with the first task 121 is contingent on completion of the second task 121 and approval by the first party 101. As such, the fourth sub-party is not beholden to the first sub-party for payment to the extent that payment may be delayed or unreasonably withheld and so on.

According to an example, approval of a request for payment by the first party 101 can comprise the first party 101 querying the data structure 109 in order to determine whether the request is appropriately linked a funding instance 107 and/or that an associated task is completed. Furthermore, although not specifically depicted in FIG. 1, one or more payments triggered as a result of a payment request can also result in a payment to the first party 101. For example, with reference to FIG. 1, upon completion of the first task 119 and the second task 121, the first party 101 may submit a payment request to the apparatus 115 which can trigger a set of payments that also cascade down the hierarchy of sub-parties associated with the first task 119 and the second task 121.

According to an example, memory 113 of apparatus 115 can comprise a digital ledger or a copy of a distributed digital ledger. For example, memory 113 can comprise data representing a distributed digital ledger, which can comprise a blockchain for example, such as first, second or third generation blockchain. Data related to project transactions, such as payment requests, payment approvals, funding instances and so on can be stored as, e.g., records on the digital ledger and/or distributed digital ledger. As such, apparatus 115 can form a node provided as part of a peer-to-peer network 250 for the purposes of addition and validation of new transaction blocks. In some examples, a distributed digital ledger of the apparatus 115 can be a permissioned distributed digital ledger, such as a permissioned blockchain for example, thereby enabling access only to a predefined set of privileged users, such as the parties described above for example. In some examples, apparatus 115 can comprise a node of a digital ledger such as a Holochain.

Examples in the present disclosure can be provided as methods, systems or machine-readable instructions, such as any combination of software, hardware, firmware or the like. Such machine-readable instructions may be included on a computer readable storage medium (including but not limited to disc storage, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. In some examples, some blocks of the flow diagrams may not be necessary and/or additional blocks may be added. It shall be understood that each flow and/or block in the flow charts and/or block diagrams, as well as combinations of the flows and/or diagrams in the flow charts and/or block diagrams can be realized by machine readable instructions.

The machine-readable instructions may, for example, be executed by a machine such as a general-purpose computer, a platform comprising user equipment such as a smart device, e.g., a smart phone, a special purpose computer, an embedded processor or processors of other programmable data processing devices to realize the functions described in the description and diagrams. In particular, a processor or processing apparatus may execute the machine-readable instructions. Thus, modules of apparatus (for example, a module implementing a digital wallet 111, authentication module 209, and a data structure 109 and so on) may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate set etc. The methods and modules may all be performed by a single processor or divided amongst several processors.

Such machine-readable instructions may also be stored in a computer readable storage that can guide the computer or other programmable data processing devices to operate in a specific mode. For example, the instructions may be provided on a non-transitory computer readable storage medium encoded with instructions, executable by a processor.

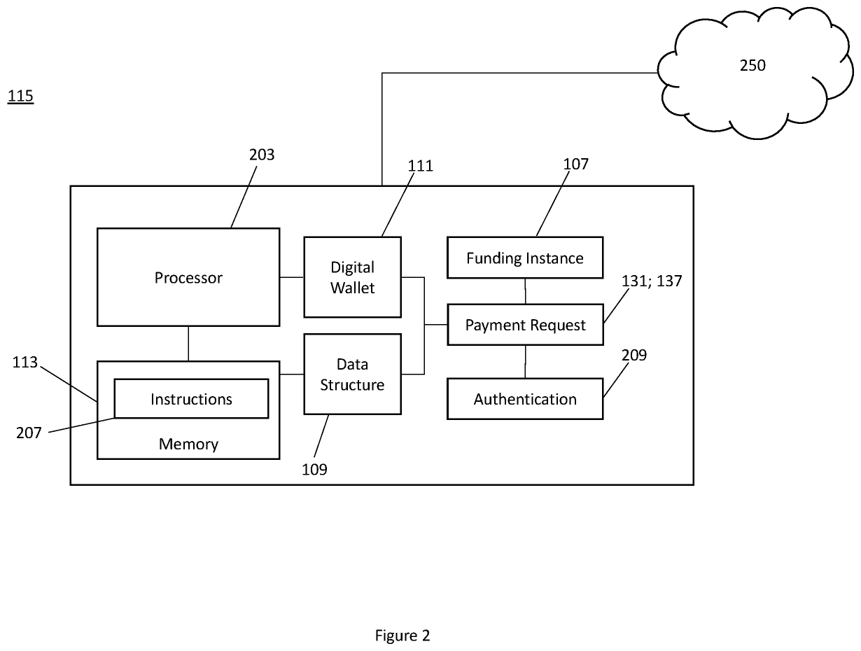

FIG. 2 is a schematic representation of a machine according to an example. The machine can be, e.g., a system or apparatus (e.g., 115), user equipment, or part thereof. The machine, which will be referred to as apparatus 115, comprises a processor 203, and a memory 113 to store instructions 207, executable by the processor 203. The memory 113 can be used to store data representing the digital wallet 111 and/or the data structure 109 and so on as described above with reference to FIG. 1.

The instructions 207, executable by the processor 203, can cause the apparatus 115 to receive data representing a funding instance, the data defined according to a preconfigured contract between a first party and a funding party, receive, from the first party, request data comprising a tuple defining at least one of a payment request, a payment party, and a payment amount, process the request data to parse a set of payment information for the first party and the set of sub-parties, determine, using the payment information, at least one entry in the data structure comprising an approved funding source of the payment request, execute a payment order to at least the first party and the set of sub-parties, and modify at least one entry of the data structure, whereby to reflect execution of the payment order.

Accordingly, the apparatus 115 can implement a method for executing payment in a trusted environment comprising a first party and a set of sub-parties defining a hierarchical structure of payees.

Apparatus 115 can therefore be part of a trusted environment, as described above, comprising a data structure defining a digital wallet for the trusted environment. In an example, the trusted environment can be configured to prevent unauthorized access to the apparatus 115 by parties without, e.g., sufficient privileges to do so. The apparatus may therefore include an authentication module 209 configured to challenge access to the apparatus 115 and only enable authorized users (who may be recorded as such as part of the data structure 109 for example) to have access to the system, e.g., for the purposes of submitting a payment request and/or querying the data structure 109 and so on. Such authentication can also be used to enable access to, e.g., a permissioned distributed digital ledger, such as a permissioned blockchain for example.

Such machine-readable instructions may also be loaded onto a computer or other programmable data processing devices, so that the computer or other programmable data processing devices perform a series of operations to produce computer-implemented processing, thus the instructions executed on the computer or other programmable devices provide an operation for realizing functions specified by flow(s) in the flow charts and/or block(s) in the block diagrams.

Further, the teachings herein may be implemented in the form of a computer or software product, such as a non-transitory machine-readable storage medium, the computer software or product being stored in a storage medium and comprising a plurality of instructions, e.g., machine readable instructions, for making a computer device implement the methods recited in the examples of the present disclosure.

In some examples, some methods can be performed in a cloud-computing or network-based environment. Cloud-computing environments may provide various services and applications via the Internet. These cloud-based services (e.g., software as a service, platform as a service, infrastructure as a service, etc.) may be accessible through a web browser or other remote interface of the user equipment for example. Various functions described herein may be provided through a remote desktop environment or any other cloud-based computing environment.

While various embodiments have been described and/or illustrated herein in the context of fully functional computing systems, one or more of these exemplary embodiments may be distributed as a program product in a variety of forms, regardless of the particular type of computer-readable-storage media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein. In addition, one or more of the modules described herein may transform data, physical devices, and/or representations of physical devices from one form to another.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

1. A machine-readable storage medium encoded with instructions for executing payment in a trusted environment comprising a first party and a set of sub-parties defining a hierarchical structure of payees, the instructions executable by a processor of an apparatus comprising a memory configured to store a data structure defining at least one digital wallet for the trusted environment, whereby to cause the apparatus to:
receive data representing a funding instance, the data defined according to a preconfigured contract between the first party and a funding party;
receive, from the first party, request data comprising a tuple defining at least one of a payment request, a payment party, and a payment amount;
process the request data to parse a set of payment information for the first party and the set of sub-parties;
determine, using the payment information, at least one entry in the data structure comprising an approved funding source of the payment request;
execute a payment order to at least the first party and the set of sub-parties; and
modify at least one entry of the data structure, whereby to reflect execution of the payment order.

2. The machine-readable storage medium as claimed in claim 1, encoded with further instructions, whereby to cause the apparatus to:
request, on the basis of the data representing the funding instance, attestation data relating to the funding instance and defining a payment structure therefor.

3. The machine-readable storage medium as claimed in claim 1, encoded with further instructions, whereby to cause the apparatus to:
determine a fee to be applied; and
modify at least one entry of the data structure, whereby to reflect application of the fee to one or more of an amount of the payment order, and an amount of the funding instance.

4. The machine-readable storage medium as claimed in claim 1, encoded with further instructions, whereby to cause the apparatus to:
record data related to at least one of a funding instance, a payment request, a payment party, a payment amount, payment information, an approved funding source of the payment request, and a payment order to a digital ledger.

5. The machine-readable storage medium as claimed in claim 4, encoded with further instructions, whereby to cause the apparatus to:
regulate access to the digital ledger using an authentication module.

6. A method, performed in apparatus of a trusted environment comprising a data structure defining a digital wallet for the trusted environment, the method comprising:
receiving, from a first party, data representing a funding instance, the data defined according to a preconfigured contract between the first party and a funding party;
receiving request data comprising a tuple defining at least one of a payment request, a payment party, and a payment amount;
processing the request data to parse a set of payment information;
determining, using the payment information, at least one entry in the data structure comprising an approved funding source of the payment request;
executing a payment order to at least the first party and a set of sub-parties defining a hierarchical structure of payees; and
modifying at least one entry of the data structure, whereby to reflect execution of the payment order.

7. The method as claimed in claim 6, further comprising:
requesting, on the basis of the data representing the funding instance, attestation data relating to the funding instance and defining a payment structure therefor.

8. The method as claimed in claim 6, further comprising:
determining a fee to be applied; and
modifying at least one entry of the data structure, whereby to reflect application of the fee to one or more of an amount of the payment order, and an amount of the funding instance.

9. The method as claimed in claim 6, further comprising:
recording data related to at least one of a funding instance, a payment request, a payment party, a payment amount, payment information, an approved funding source of the payment request, and a payment order to a digital ledger.

10. The method as claimed in claim 9, further comprising:
regulating access to the digital ledger using an authentication module.

11. An apparatus of a trusted environment comprising a data structure defining a digital wallet for the trusted environment, the apparatus comprising:
a processor;
a memory coupled to the processor, the memory configured to store program code executable by the processor, the program code comprising one or more instructions, whereby to cause the apparatus to:
receive, from a first party, data representing a funding instance, the data defined according to a preconfigured contract between the first party and a funding party;
receive request data comprising a tuple defining at least one of a payment request, a payment party, and a payment amount;
process the request data to parse a set of payment information;
determine, using the payment information, at least one entry in the data structure comprising an approved funding source of the payment request;
execute a payment order to at least the first party and a set of sub-parties defining a hierarchical structure of payee; and
modify at least one entry of the data structure, whereby to reflect execution of the payment order.

12. The apparatus as claimed in claim 11, the program code comprising further instructions, whereby to cause the apparatus to:
request, on the basis of the data representing the funding instance, attestation data relating to the funding instance and defining a payment structure therefor.

13. The apparatus as claimed in claim 11, the program code comprising further instructions, whereby to cause the apparatus to:
determine a fee to be applied; and
modify at least one entry of the data structure, whereby to reflect application of the fee to one or more of an amount of the payment order, and an amount of the funding instance.

14. The apparatus as claimed in claim 11, the program code comprising further instructions, whereby to cause the apparatus to:
record data related to at least one of a funding instance, a payment request, a payment party, a payment amount, payment information, an approved funding source of the payment request, and a payment order to a digital ledger.

15. The apparatus as claimed in claim 14, the program code comprising further instructions, whereby to cause the apparatus to:
regulate access to the digital ledger using an authentication module.
